(19) United States
(12) Patent Application Publication
(10) Pub. No.: US 2007/0130594 A1
(43) Pub. Date: Jun. 7, 2007

(54) Method and system for distributing content using podcasting

(76) Inventors: Murray Hidary, New York, NY (US); Joel Kehle, Los Angeles, CA (US)

Correspondence Address: GOTTLIEB RACKMAN & REISMAN PC, 270 MADISON AVENUE, 8TH FLOOR, NEW YORK, NY, 100160601, US

(21) Appl. No.: 11/291,156

(22) Filed: Dec. 1, 2005

(51) Int. Cl. H04N 7/173

(52) U.S. Cl. 725/86; 725/87; 725/110; 725/109

(57) ABSTRACT

A system is provided for streaming content to individual subscribers using podcasting technology. Each subscriber to the system is assigned a unique URL number that he uses to obtain content from a server. The server maintains a set of rules or attributes associated with each subscriber, said rules governing or controlling the download of the content. Some rules may pertain to the number of times a subscriber can download content. Other rules are applicable for multipart content transfer and allow each subscriber to obtain the content parts independently of the other subscribers. The system can also receive podcasts from several podcasters, cache the podcasts and deliver them to a subscriber in a concatenated form on demand.

### PRIOR APPLICATIONS

None

### BACKGROUND OF THE INVENTION

A. Field of Invention This invention pertains to publishing of content using podcasting, and more particularly to a system in which a number of different subscribers can download specific content, each subscriber being assigned a unique address.

B. Description of the Prior Art

Sending and receiving audio and video files using the Internet can be performed using various schemes, involving various types push or pull technologies. A particularly useful scheme is podcasting. Podcasting is a means of distributing audio and video programs via the Internet that lets users subscribe to a number of files, also known as “feeds,” and then hear or view the material at the time that they choose.

“Podcasting” is distinct from other types of online media delivery because of its subscription model, rather than one-time delivery. A series of files are delivered to allow subscribers to get the information regularly.

Subscriptions use a “feed” (such as RSS or Atom) to deliver the enclosed files. Podcasting enables independent producers to create self-published, syndicated “radio shows,” and gives broadcast radio or television programs a new distribution method.

In order to use podcasting, a receiver installs appropriate “pod-caching” software on his device, usually a PC-type device. He then connects the device over the Internet to a designated website, identified by a URL, and then the software on his device periodically checks for and downloads new content automatically.

A problem with standard podcasting systems is that the publisher has no control over who accesses their content. All receivers access the content using the same URL. There is no mechanism for restricting access to the content. This makes it impossible to control the size of the audience or to charge the audience for the content.

Another problem is that podcasting as it is presently implemented makes content available for delivery to all users at the same time. For example for a program that is delivered weekly, a party who subscribed during the second week will either get week one and two at once, or miss week one entirely.

### SUMMARY OF THE INVENTION

In the present system, content is distributed using a private podcasting scheme. In this scheme, a potential subscriber first contacts a publisher, or a third party and receives a URL. Preferably, each subscriber receives a unique URL associated with him. In an alternate embodiment, a limited number of subscribers are provided with a unique URL. In this later scheme, the number of such subscribers is limited and/or the identity of the subscribers is known to the content publisher or the third party. Once a subscriber receives the unique URL, he can access the corresponding website and he can receive the respective content. The publisher, or the server from which the content is made available can monitor the downloading of the content, including who accesses and downloads the content, how often is the content downloaded, etc.

### BRIEF DESCRIPTION OF THE DRAWINGS

FIG. 1 shows a block diagram for a standard podcasting system;

FIG. 2 shows a block diagram for a private podcasting system constructed in accordance with this invention;

FIG. 3 shows a list of subscribers to the system of FIG. 2 and various attributes of these subscribers that are used to determine what content is made available to them;

FIG. 4A shows a block diagram of a prior art system wherein a user receives and caches several podcasts from several podcasters; and

FIG. 4B shows a block diagram of a novel system wherein a podcast aggregator is used to collect podcasts for different users;

### DETAILED DESCRIPTION OF THE INVENTION

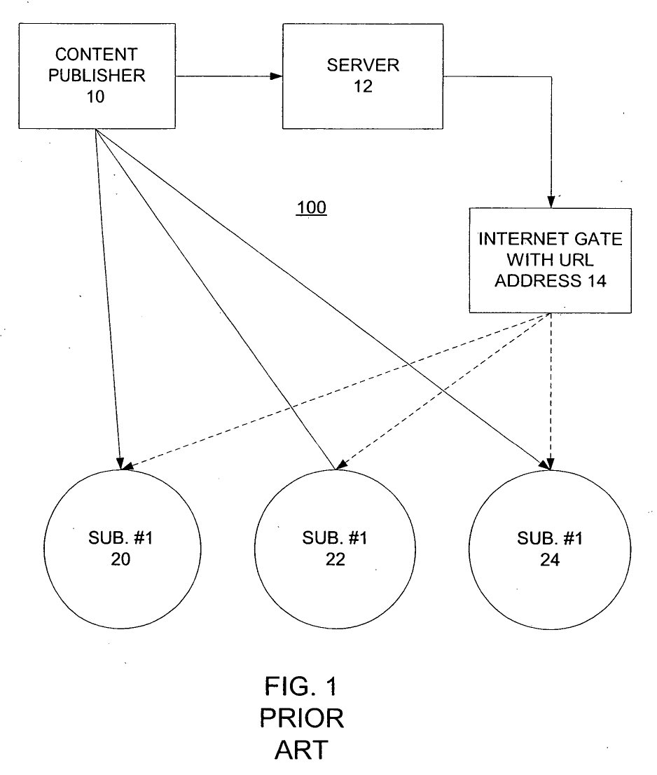

FIG. 1 shows more details of a known system 100. In this system, content publisher 10 sends content to a server 12. The server makes the content available to an interested party over an Internet gate 14 associated with a URL address. The content publisher also distributes the URL address of gate 14 indiscriminately to many parties, including person #1, #2, and # 3 identified respectively by numerals 20, 22, 24. The persons then connect to gate 14 and each receives the content in a stream in accordance with standard podcasting protocol.

As discussed above, the content publisher has no control over who the persons are and everyone received the same content.

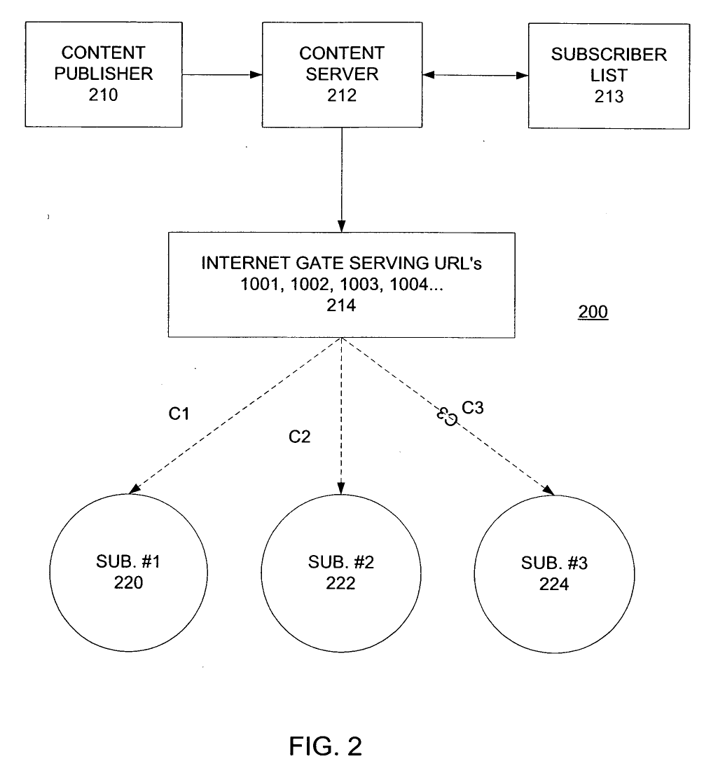

A novel system 200 for distributing content is shown in FIG. 2. In this system, subscriber #1 first contacts the content publisher 210 (or a third party) and obtains a unique URL. As part of this step, the subscriber may be given various options associated with the content delivery. In one embodiment, these options may be related to payment by the subscriber for the content. One option may be a time duration/limitation. That is, the subscriber may be given the right specific content for a particular length of time (e.g. a week) or until a particular expiration date (e.g. Dec. 1, 2005). At the end of that time, the subscription expires, and the subscriber has no more access to the content anymore. Another option is to allow the subscriber the right to download content a predetermined number of times. This scheme insures that the subscriber does not just redistribute his assigned URL indiscriminately to others.

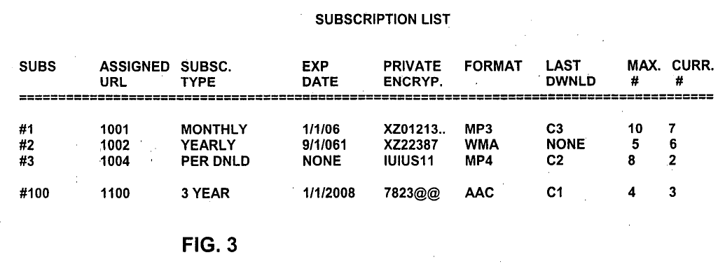

Returning now to FIG. 2, in system 200, the content publisher provides the content to the content server 212. The content server is associated with one or more Internet gates 214 that service a plurality of URL's 1001, 1002, 1003, 1004 etc. The content server 212 also maintains a list or table providing information about each subscriber. A typical list is shown in FIG. 3 and may include entries for each private subscriber including the URL assigned to the subscriber, expiration date and/or special rules or other terms of service applicable to the subscriber, and so forth. As discussed above, initially each subscriber 220, 222, 224 negotiates with the content server 210 and obtains a private and unique URL. The subscribers can then each contact gate 214 and request content.

For example, when subscriber #1 contacts gate 214, the gate 214 and the server 212 cooperate to determine whether content is available for the subscriber. This determination is made using the information from the list 213. The content is then downloaded to the subscriber using podcasting protocol and software resident on the device 220 of subscriber #1. The content may be encrypted to provide security. If the subscription of the subscriber #1 has expired, or if the content has been downloaded previously an excessive number of times in contradiction to the original terms of service, then the request for content is refused.

One advantage of the system is that it provides the content publisher and/or server with better controls on how the content is provided to various subscribers or, even in what format. For example, one subscriber (e.g., #2) may decide that he wants to receive content in a one format while another subscriber (e.g., #3) may want to receive the same content in a different format. The server converts the content to the right format before streaming to the respective subscriber.

Another advantage of the system is that the content publisher can distribute content in timed or sequenced installments to different subscribers. For example, if the requested content has several parts, such as C1, C2, C3 then each of the subscribers can get the appropriate parts at the appropriate time, or appropriate sequence. For example, the first time a subscriber requests content, he may be provided with C1. The second time he signs up, he receives C2, the third time he signs up, he receives C3. Alternatively, the content parts may be arranged in a timed sequence. For example, the content may consists of sequences of exercises, each sequence being tailored to be executed for a month. Therefore, each time subscriber #2 requests content during the first month, he receives part C1, during the second month, he can receive part C2, and so on.

FIG. 3 is illustrative of some entries for various entries and attributes for a set of subscribers. As shown in this list, each subscriber is assigned a URL number. The list also indicates whether a subscriber is paying monthly, yearly, or by download, a private encryption key assigned to each subscriber, the format in which he prefers to get the content, etc. As illustrated in FIG. 3, the content may be a multimedia program in either MP3, WMA, MP4, AAC or other formats used for either audio, or audio and video programs.

The LAST DNLD (Last download) column refers to publishing multi-part content, comprising parts C1, C2, C3. As indicated in this column, subscriber #1 has already downloaded the last part—C3. Subscriber C2 has not downloaded any parts yet. If he contacts his URL (1002), he will receive part C1. Subscriber #3 has downloaded C2. Next time he access his URL, he will receive part C2. Similarly subscriber #100 will receive C2.

The next two columns (MAX # and CURR #) indicate the number of times the same content can be downloaded by a particular subscriber. This attribute is more suitable for a single part download. As shown in the Figure, subscriber #1 can download a program ten times, and he is now downloading the seventh copy. Subscriber #2 has downloaded all his allowable copies (5) and he is now attempting sixth download. Because this exceeds his limit, the download is aborted. Similarly, subscriber #3 has downloaded two of his allowable eight copies, subscriber #100 has downloaded three of his allowable four copies, etc. Different attributes are being shown in FIG. 3 for different subscribers for illustration purposes, it being understood that the content publisher may elect to use a unified set of rules for all its subscribers.

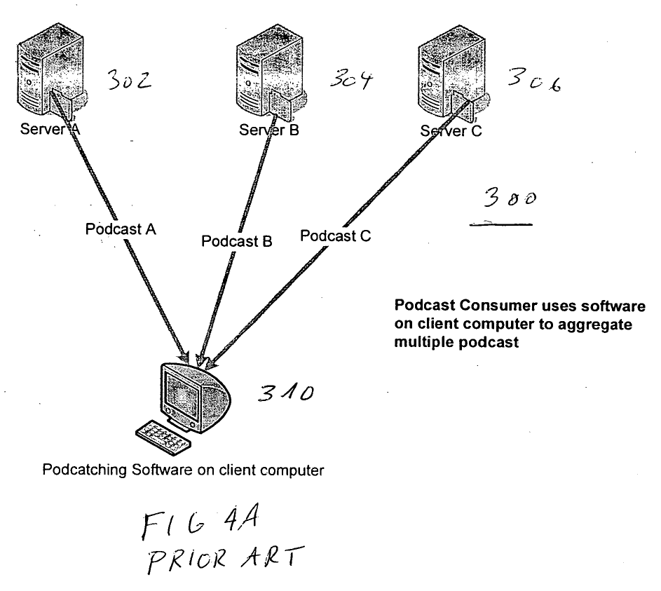

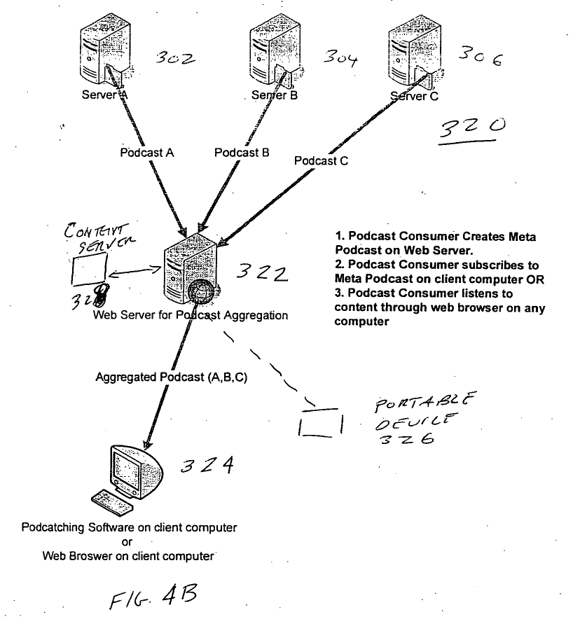

Another problem addressed by the present application is that presently users subscribing to a number of podcasts from different servers are simply caching them on the receiving device (e.g., a client PC) using the standard podcaching software. As a result, the users can access these podcasts only while they are at or near the receiving device. Another disadvantage of the existing process is that while a user may have many podcasts cached on his device, the list of these podcasts is private in the sense that it is very difficult to share the list or the podcasts with others. Finally, a further problem with the existing system is that the podcaster does not get any information about the user, including user preferences, interests, etc. The existing system 300 is shown somewhat diagrammatically in FIG. 4A three podcasters 302, 304, 306 send podcasts A, B and C to a device 310 that may be a client computer. Device 310 then stores or caches this podcasts in a memory (not shown) and replays them on demand from a user.

In novel system 320 shown in FIG. 4B a podcast intermediate server 322 is provided. A user signs up as a subscriber on a website, associated for example with a content server 328 similar to content server 212 in FIG. 2 and specifies a list of podcasts that he is interested in. The list and the subscribers are provided to server 322. The server 322 receives and caches the podcasts A, B, C and any other podcasts that its subscribers have identified. Each subscriber can then access the server 322 and receive all the podcasts that he has requested on demand. Moreover, the requested podcasts can be downloaded either to the subscriber's device 324 where it is cached in the normal fashion, or to any other device designated by the subscriber, such as a portable device 326.

This system has a number of advantages over the prior art of FIG. 4A. First, the users can access their podcasts from any computer or other device connected to the Internet. The users can either configure podcaching on multiple computers, or can listen to one or more podcasts using any web browser. Second, the users can readily share podcasting collections since their list of podcasts is stored on the server 322 and readily available for publication. Third, the content server 328 can monitor the lists of podcasts received by aggregating server 322, can mine data from these lists, and generate reports and statistics for the podcasts publishers and other entities, such as the top ten podcasts received by women, the top three podcasts received by young professionals, etc.

Server 322 operates as follows. First, it receives and stores all the podcast lists from every one of its subscribers. The URL of server 322 is registered with the podcast servers 302, 304, 306, etc. All podcasts from these servers are then received and cached by the server 322. When a podcast client or subscriber accesses the server 322 and requests his podcasts, the server 322 dynamically concatenates the requested podcasts and downloads them either to device 324 or any other device, e.g., 326. The device 324 or 326 then processes the concatenated podcasts in the normal manner. All podcasts are compatible with the RRS standard and the concatenated list downloaded to devices 324. 326 using the format used by each device.

A subscriber or user of system 320 can request and obtain the concatenated podcasts using a standard podcast protocol. That is the server 322 itself acts in this case as a podcaster, receives a meta podcast URL address from the subscriber and in response downloads to a subscriber the concatenated podcasts using podcasting protocol.

Alternatively, server 322 is setup with a browser-based player. A subscriber then access the server 322 and user then access the content (e.g. the podcasts he has requested) from any browser. For this embodiment, the device (e.g., 326) must be able to play audio and video content.

Obviously numerous modifications may be made to this invention without departing from its scope as defined in the appended claims.

We claim:

1. A method of distributing content to several subscribers comprising:
assigning a URL to each subscriber;
establishing communication between one of said subscribers and a content server over the Internet using the URL assigned to said one subscriber; and
transmitting content to said subscriber.

2. The method of claim 1 further comprising providing a set of rules governing the delivery of content dependent on subscriber attributes, wherein said transmitting is performed in accordance with said set of rules.

3. The method of claim 3 wherein said rules include the number of times that content can be downloaded by said one of said subscribers.

4. The method of claim 1 wherein said rules include a time limitation that limits when content can be downloaded.

5. A system for distributing content to several subscribers, each subscriber being assigned a unique URL comprising:
a content server receiving content; and
an Internet gate adapted to send each subscriber specific content in accordance with a set of predetermined rules.

6. The system of claim 5 wherein said content includes several content segments and wherein said subscribers receive said content segments in a predetermined sequence.

7. The system of claim 6 wherein a first subscriber receives a specific content segment at a different time then a second subscriber.

8. The system of claim 7 wherein the timing of when said first subscriber receives said specific content is determined by the time when the subscriber initiates service from the system.

9. The system of claim 5 wherein said gate podcasts said content to said subscribers.

10. The system of claim 5 wherein said content includes at least one of a text, an audio clip, a video clip and a multimedia content segment.

11. The system of claim 5 further comprising a data storage with a data base listing said subscribers.

12. The system of claim 11 wherein said data storage includes said rules.

13. The system of claim 5 wherein each subscriber requests content from said server to initiate content transfer.

14. The system of claim 5 wherein said subscribers provide payment for said content, said payment being correlated by said set of rules to determine the content being delivered to each subscriber and the timing of the delivered content.

15. The system of claim 5 wherein content is delivered to the subscribers over the Internet.

16. A system for aggregating podcasts from several content providers for several subscribers, comprising:
a plurality of content servers, each content server delivering content in form of a respective podcast; and
an aggregating server storing a plurality of podcasts, each podcast being associated with at least one subscriber, said aggregating server being adapted to receive a request from a subscriber, and in response to said request sending said subscriber an aggregated podcast including several podcasts from different servers.
